(19) United States
(12) Patent Application Publication
(10) Pub. No.: US 2021/0272077 A1
(43) Pub. Date: Sep. 2, 2021

(54) SERVER

(71) Applicant: KUROSU INFORMATION SYSTEM TECHNICAL RESEARCH INSTITUTE, INC., Tokyo (JP)

(72) Inventor: Masato HASEGAWA, Tokyo (JP)

(21) Appl. No.: 17/318,743

(22) Filed: May 12, 2021

Related U.S. Application Data
(63) Continuation of application No. PCT/JP2019/043899, filed on Nov. 8, 2019.

(30) Foreign Application Priority Data
Nov. 13, 2018 (JP) 2018-213246

(51) Int. Cl. G06Q 20/06; G06Q 20/36; G06Q 20/10; G06Q 20/38; G06Q 40/04

(52) U.S. Cl. CPC G06Q 20/0658; G06Q 20/3678; G06Q 40/04; G06Q 20/383; G06Q 20/10

(57) ABSTRACT

A server is connected to an electronic device and systems of a plurality of cryptocurrency exchanges over a network. An information reception unit receives first board information and second board information from systems of first and second cryptocurrency exchanges that conduct buy-sell transactions of a cryptocurrency in first and second main currencies, respectively. A conversion unit converts second limits into third limits in a first main currency based on an exchange rate between the first and second main currencies. A totalization unit calculates a total order quantity obtained by totalizing buy-sell order quantities in the first board information and the second board information, for each of fourth limits into which first limits and the third limits are joined. Third board information that includes total order quantities corresponding to the fourth limits in the first board information and the second board information is displayed on the electronic device.

### CROSS-REFERENCE TO RELATED APPLICATIONS

This application is a continuation application of International Patent Application No. PCT/JP2019/043899 filed on Nov. 8, 2019, which is based upon and claims the benefit of priority from the prior Japanese Patent Application No. 2018-213246, filed Nov. 13, 2018 the entire contents of which are incorporated herein by reference.

### FIELD

Embodiments described herein relate generally to a server that controls display of pieces of board information in cryptocurrency exchanges.

### BACKGROUND

Cryptocurrency exchanges are opened on the Internet and provide services such as trading cryptocurrencies. The services provided by the cryptocurrency exchanges are available on electronic devices such as personal computers and smartphones over the Internet.

In general, a plurality of cryptocurrency exchanges are opened for one cryptocurrency. In addition, the plurality of cryptocurrency exchanges conduct transactions such as trading the cryptocurrency independently of one another even in a case where the cryptocurrency exchanges deal in a common cryptocurrency. In addition, there is a case where the plurality of cryptocurrency exchanges use different main currencies for trading a cryptocurrency.

A cryptocurrency exchange determines a base price indicating a market price between a cryptocurrency and a main currency in accordance with a situation of transactions of selling limit orders and buying limit orders from users. The base price is a price that indicates a market price at a time point between the cryptocurrency and the main currency in a cryptocurrency exchange and is a price indicating, for example, any point between a lowest selling limit order and a highest buying limit order. Note that the prices each indicating any point are determined, for example, based on different criteria, such as a final market price, an average of a lowest selling limit and a highest buying limit, between cryptocurrency exchanges. For example, in a case of a cryptocurrency exchange of which a main currency is Japanese yen, the base price is expressed as “1 unit of cryptocurrency=835000 yen”.

### SUMMARY OF THE INVENTION

### Technical Problem

As stated above, the plurality of cryptocurrency exchanges determine their base prices and conduct trading of the cryptocurrency independently of one another even in a case where the cryptocurrency exchanges deal in a common cryptocurrency. However, in actuality, for example, when a huge sell order or buy order occurs in any of the cryptocurrency exchanges, this order has an influence on market prices (base prices) of the other cryptocurrency exchanges dealing in the same cryptocurrency. Therefore, even in a case of trading a cryptocurrency in one cryptocurrency exchange, it is necessary to check a situation of transactions in other cryptocurrency exchanges. However, since the other cryptocurrency exchanges conduct transactions in the cryptocurrency independently of one another, it is not easy to check situations of selling limit orders and buying limit orders in the plurality of cryptocurrency exchanges in their main currencies in an integrated manner.

An objective of the present invention is to allow a situation of transactions in a common cryptocurrency in a plurality of cryptocurrency exchanges of which main currencies are the same or different from one another to be checked easily.

### Solution to Problem

A server according to the present embodiment is a server that is connected to an electronic device and systems of a plurality of cryptocurrency exchanges over a network, the server including: an information reception unit configured to receive, from a system of a first cryptocurrency exchange that conducts buy-sell transactions of a cryptocurrency in a first main currency, first board information that includes a buy-sell order quantity for each of a plurality of first limits in the first main currency with respect to the cryptocurrency and receive, from a system of a second cryptocurrency exchange that conducts buy-sell transactions of the cryptocurrency in a second main currency, second board information that includes a buy-sell order quantity for each of a plurality of second limits in the second main currency with respect to the cryptocurrency; a conversion unit configured to convert the second limits into third limits in the first main currency based on the exchange rate between the first main currency and the second main currency; a totalization unit configured to calculate a total order quantity obtained by totalizing buy-sell order quantities in the first board information and the second board information, for each of fourth limits into which the first limits and the third limits are joined; and a display unit configured to display third board information that includes the total order quantities corresponding to the fourth limits in the first board information and the second board information, on the electronic device.

According to the present embodiment, a situation of transactions in a common cryptocurrency in a plurality of cryptocurrency exchanges of which main currencies are the same or different from one another can be checked easily.

### BRIEF DESCRIPTION OF THE VIEWS OF THE DRAWING

FIG. 1 is a block diagram illustrating a configuration of a system in the present embodiment;

FIG. 2 is a block diagram illustrating a configuration of an integration server in the present embodiment;

FIG. 3 is a flowchart for explaining an integrated board information display process performed by the integration server in the present embodiment;

FIG. 4 is a diagram illustrating an example of board information data in the present embodiment;

FIG. 5 is a diagram illustrating an example of an overall setting screen in the present embodiment;

FIG. 6 is a flowchart for explaining an integration process according to a simple integration method in the present embodiment;

FIG. 7 is a diagram illustrating an example of integrated board information integrated into by the simple integration method in the present embodiment;

FIG. 8 is a flowchart for explaining an integration process according to a first integration method in the present embodiment;

FIGS. 9A, 9B, and 9C are diagrams illustrating an example of pieces of board information received from cryptocurrency exchanges;

FIGS. 10A and 10B are diagrams illustrating an example in which limits in a piece of board information of which a main currency is United States dollar are converted into limits in Japanese yen;

FIGS. 11A, 11B, and 11C are diagrams illustrating an example of pieces of board information of which main currencies are converted;

FIG. 12 is a diagram illustrating an example of integrated board information integrated into by the first integration method in the present embodiment;

FIG. 13 is a flowchart for explaining an integration process according to a second integration method in the present embodiment;

FIGS. 14A and 14B are diagrams illustrating an example of converting limits in a piece of board information on a cryptocurrency exchange;

FIGS. 15A, 15B, and 15C are diagrams illustrating an example of pieces of board information into which limits in the pieces of board information are converted into limits indicating ratios with respect to their base prices;

FIG. 16 is a diagram illustrating an example of integrated board information into which pieces of board information are integrated in accordance with ratios corresponding to limits in the pieces of board information;

FIGS. 17A and 17B are diagrams illustrating an example of integrated board information integrated into by the second integration method in the present embodiment;

FIG. 18 is a flowchart for explaining an integration process according to a third integration method in the present embodiment;

FIGS. 19A, 19B, and 19C are diagrams illustrating an example of pieces of board information received from cryptocurrency exchanges;

FIGS. 20A and 20B are diagrams illustrating an example in which limits are converted into relative values with respect to base prices;

FIGS. 21A, 21B, and 21C are diagrams illustrating pieces of board information on cryptocurrency exchanges;

FIG. 22 is a diagram illustrating an example of integrated board information into which pieces of board information are integrated in accordance with relative values of limits with respect to base prices of the pieces of board information;

FIGS. 23A and 23B are diagrams illustrating an example of dividing limits in board information by a first aggregation process in the present embodiment;

FIG. 24 is a diagram illustrating an example of data included in integrated board information after a first aggregation process in the present embodiment;

FIGS. 25A and 25B are diagrams illustrating an example of dividing limits in board information by a second aggregation process in the present embodiment; and

FIG. 26 is a diagram illustrating an example of generating integrated board information by a third aggregation process in the present embodiment.

### DETAILED DESCRIPTION

An embodiment of the present invention will be described below with reference to the drawings.

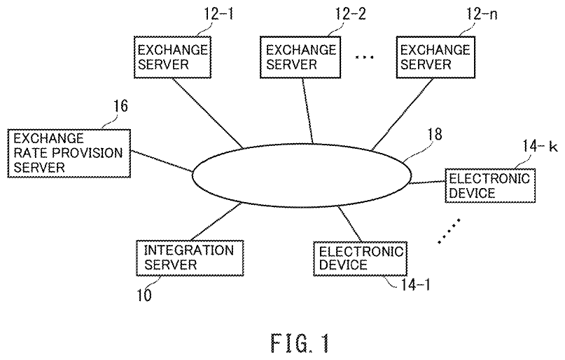

FIG. 1 is a block diagram illustrating a configuration of a system in the present embodiment. In the system illustrated in FIG. 1, an integration server 10 integrates pieces of board information (e.g., orderbook) on a plurality of cryptocurrency exchanges received from a plurality of exchange server systems 12 (12-1, 12-2, . . ., 12-n) and displays the pieces of board information on electronic devices 14 (14-1, . . ., 14-k) used by users. The integration server 10 receives exchange rates between main currencies exchanged in the plurality of cryptocurrency exchanges from an exchange rate provision server 16 and integrates the pieces of board information by linking together limits in the pieces of board information on the plurality of cryptocurrency exchanges based on exchange rates.

The integration server 10, the exchange server systems 12, the electronic devices 14, and the exchange rate provision server 16 are connected with one another over a network 18 including the Internet.

The exchange server systems 12 (12-1, 12-2, . . ., 12-n) are for opening cryptocurrency exchanges on the Internet and provide various kinds of services relating to trading cryptocurrencies. The services provided by the cryptocurrency exchanges are available on the electronic devices 14 such as personal computers and smartphones over the Internet. In the following description, it is assumed that the plurality of cryptocurrency exchanges opened by the exchange server systems 12 deal in a common cryptocurrency. Hereinafter, a cryptocurrency dealt in by the plurality of cryptocurrency exchanges in common may be denoted by “BTC”. In addition, the plurality of cryptocurrency exchanges conduct transactions such as trading the cryptocurrency independently of one another. Furthermore, main currencies used by the plurality of cryptocurrency exchanges for trading the cryptocurrency may be the same or may be different from one another, base prices are determined by the exchanges independently of one another; therefore, a situation of transactions of a cryptocurrency cannot be grasped intuitively even when the cryptocurrency is common, which becomes significant when the main currencies are different from one another. Although the present embodiment is applicable to a case where main currencies are the same and a case where the main currencies are different from one another, the description will be given here mainly about a case where the main currencies are different from one another, in which the present embodiment is more effective to grasp a situation of transactions intuitively.

The exchange server systems 12 each compile a situation of transactions of selling limit orders and buying limit orders received from the electronic devices 14 into board information and provides the board information to the electronic devices 14 and the integration server 10. The electronic devices 14 each display pieces of board information provided by the exchange server systems 12 to be helpful to a user in placing an order to buy or sell the cryptocurrency.

The exchange rate provision server 16 is a server to provide information concerning exchange markets and provides information on exchange rates between currencies.

The integration server 10 receives board information data indicating the pieces of board information provided from the plurality of exchange server systems 12 and data on exchange rates between main currencies in the plurality of cryptocurrency exchanges provided from the integration server 10 to perform a process of integrating the pieces of board information on the plurality of cryptocurrency exchanges.

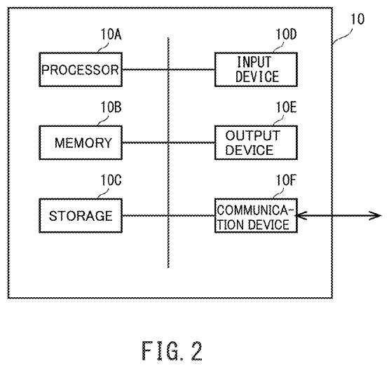

FIG. 2 is a block diagram illustrating a configuration of the integration server 10 in the present embodiment. The integration server 10 illustrated in FIG. 1 is implemented by, for example, a computer, and includes a processor 10A, a memory 10B, a storage 10C, an input device 10D, an output device 10E, and a communication device 10F.

The processor 10A generally controls the devices that are connected with the processor 10A via a system bus. The processor 10A can be configured as, for example, a central processing unit (CPU) or a graphics processing unit (GPU).

The processor 10A implements various kinds of functions by executing a program stored in the memory 10B. The processor 10A executes an integrated board information display process program according to the present embodiment to perform an integrated board information display process, in which the pieces of board information on the plurality of cryptocurrency exchanges are integrated, and integrated board information is provided to the electronic devices 14. By being executed by the processor 10A, the integrated board information display process program causes a computer to implement functional units such as an information reception unit, a conversion unit, a totalization unit, a display unit, and a determination unit.

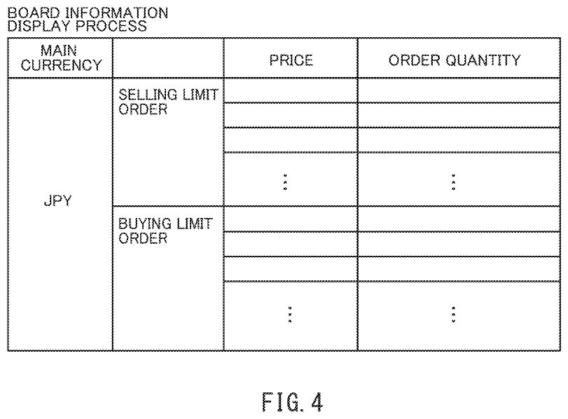

The information reception unit receives, from the plurality of cryptocurrency exchanges that deal in different main currencies, buy-sell transactions of the common cryptocurrencies (BTC) in a form of pieces of board information including a buy-sell order quantity for each of a plurality of limits in each of the main currencies dealt in by the cryptocurrency exchanges (board information data) (see FIG. 4). That is, the information reception unit receives a piece of board information including a buy-sell order quantity for each of a plurality of limits in a first main currency (e.g., Japanese yen (JPY)) with respect to the cryptocurrency from a cryptocurrency exchange A, which conducts buy-sell transactions of the cryptocurrency in the first main currency (Japanese yen) and receives a piece of board information including a buy-sell order quantity for each of a plurality of limits in a second main currency (e.g., United States dollar (USD)) with respect to the cryptocurrency from a cryptocurrency exchange B, which conducts buy-sell transactions of the cryptocurrency in the second main currency (United States dollar). Similarly, the information reception unit receives pieces of board information from other cryptocurrency exchanges that deal in different main currencies.

The conversion unit performs, based on the exchange rates between the main currencies dealt in by the cryptocurrency exchanges received from the exchange rate provision server 16, a process of converting limits in the pieces of board information into limits in other main currencies and a process of converting the limits in the pieces of board information into ratios with respect to a base price or relative values with respect to the base price.

The totalization unit performs a process of calculating a total order quantity, which is obtained by totalizing buy-sell order quantities in the pieces of board information received from the plurality of cryptocurrency exchanges for each of the limits, each of ratios of the limits with respect to the base price, or each of relative values of the limits with respect to the base price.

The display unit performs a process of displaying the integrated board information, which is obtained by integrating the pieces of board information received from the plurality of cryptocurrency exchanges, on the electronic devices 14.

The determination unit performs a process of determining correspondences between base prices of the pieces of board information received from the plurality of cryptocurrency exchanges based on the exchange rates between the main currencies dealt in by the plurality of cryptocurrency exchanges.

The memory 10B functions as a main memory, a work area, and the like for the processor 10A. The processor 10A loads programs and the like necessary to perform the processes from the storage 10C onto the memory 10B and executes the loaded programs, thereby implementing the functional units.

The storage 10C stores a basic input output system (BIOS), an operating system program (OS), and various kinds of programs, such as various kinds of application programs including an image processing program, necessary to implement various kinds of functions, the BIOS, the OS, and the various kinds of programs being to be executed by the processor 10A, and various kinds of files, various kinds of data, and the like processed by the various kinds of programs. The data stored in the storage 10C includes the board information received from the plurality of cryptocurrency exchanges (exchange server systems 12), data on the exchange rates received from the exchange rate provision server 16, and the like.

The input device 10D is a keyboard (KB), a pointing device such as a mouse and a touch panel, and the like.

The output device 10E is a display or the like. The communication device 10F controls communication with external equipment connected over the network 18 (the exchange server systems 12, the electronic devices 14, and the exchange rate provision server 16).

Next, operation of the integration server 10 in the present embodiment will be described.

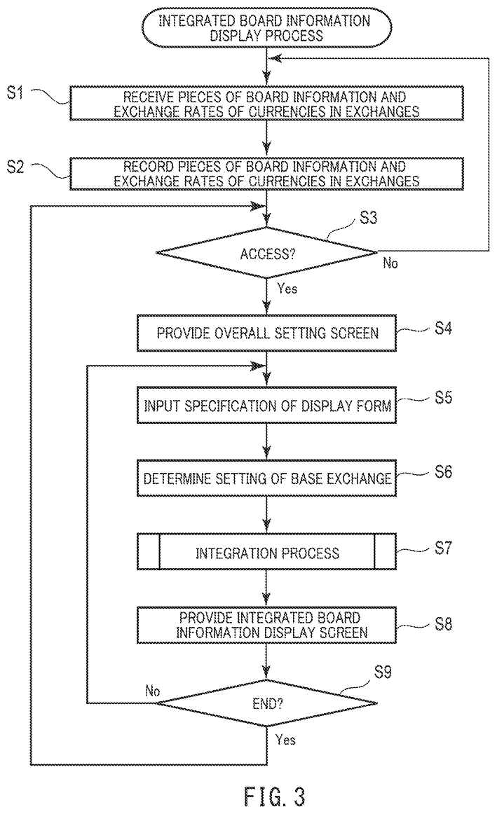

FIG. 3 is a flowchart for explaining the integrated board information display process performed by the integration server 10 in the present embodiment. Performing the integrated board information display process program stored in the memory 10B, the processor 10A of the integration server 10 implements processing described below.

The plurality of exchange server systems 12 open their respective cryptocurrency exchanges. The exchange server systems 12 each open, to the network 18, a website for providing various kinds of services relating to trading cryptocurrencies and accept accesses from the electronic devices 14. The plurality of cryptocurrency exchanges conduct transactions such as trading the cryptocurrency independently of one another and each create a piece of board information based on selling limit orders and buying limit orders received from the electronic devices 14.

The integration server 10 receives board information data indicating pieces of board information on cryptocurrency exchanges from exchange server systems 12 and receives data on exchange rates between main currencies dealt in by the plurality of cryptocurrency exchanges from the exchange rate provision server 16 (step S1). The integration server 10 stores the board information data and the data indicating the exchange rates in the storage 10C (step S2). For example, the integration server 10 continuously receives the board information and the data on the exchange rates and stores up-to-date data in the storage 10C (step S1, S2).

FIG. 4 is a diagram illustrating an example of board information data in the present embodiment. The board information data illustrated in FIG. 4 indicates an example of board information data received from a cryptocurrency exchange of which a main currency is Japanese yen (JPY). The board information data includes data items on selling limit orders and buying limit orders each indicating an order quantity for each limit.

Where accepting an access for requesting browsing the integrated board information from an electronic device 14 (Yes in step S3), the integration server 10 causes the electronic device 14 to display an overall setting screen (web page) for setting conditions for displaying the integrated board information (step S4). Note that the electronic device 14 may access directly to the website for the integrated board information opened by the integration server 10 or may access the website via a website of a cryptocurrency exchange.

Although it is assumed in the description that a program for performing a procedure of a process to be described later is installed in the integration server 10 so as to cause the integration server 10 to perform reception of board information, reception of exchange information, and an integration process, note that the program may be installed in the electronic device 14-k of a user so as to cause the electronic device 14-k to perform the reception of board information, the reception of exchange information, the integration process, and a process of displaying a result of the integration.

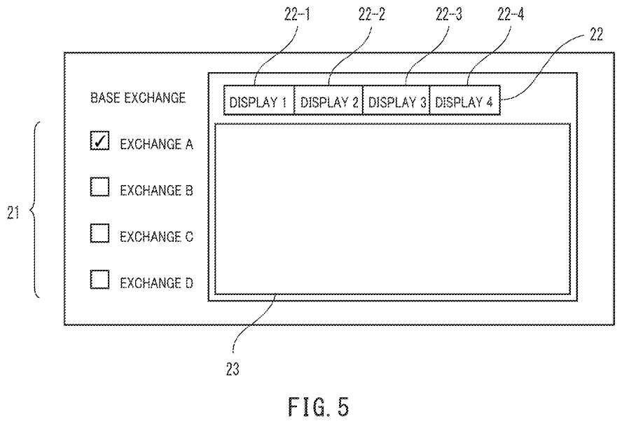

FIG. 5 is a diagram illustrating an example of an overall setting screen in the present embodiment. The overall setting screen illustrated in FIG. 5 is provided with a base exchange selection area 21, display pattern selection buttons 22, and a board information display area 23 for displaying integrated board information.

The base exchange selection area 21 is an area for selecting any one of a plurality of cryptocurrency exchanges A, B, C, and D as a base exchange. The base exchange refers to a cryptocurrency exchange that serves, in integration of pieces of board information on a plurality of cryptocurrency exchanges, as a base for converting pieces of board information on cryptocurrency exchanges other than the base exchange (referential exchange). That is, after a base exchange is selected, limits in the integrated board information can be expressed in terms of a main currency dealt in by the base exchange.

In the base exchange selection area 21, the plurality of cryptocurrency exchanges A, B, C, and D are displayed as a list, and checkboxes are provided correspondingly. By an action of marking one of the checkboxes on an electronic device 14, any one of cryptocurrency exchanges to be a base exchange can be selected.

The display pattern selection buttons 22 are buttons for specifying a display pattern of integrated board information displayed in the board information display area 23. The display pattern selection buttons 22 include, for example, display pattern buttons 22-1, 22-2, 22-3, and 22-4 that correspond to four display patterns.

The display pattern button 22-1 is a button for specifying a display pattern 1, which can command a display of integrated board information generated by an integration process according to a first integration method to be described later. The display pattern button 22-2 is a button for specifying a display pattern 2, which can command a display of integrated board information generated by an integration process according to a second integration method to be described later. The display pattern button 22-3 is a button for specifying a display pattern 3, which can command a display of integrated board information generated by an integration process according to a third integration method to be described later. The display pattern button 22-4 is a button for specifying a display pattern 4, which can command a display of integrated board information generated by an integration process according to a simple integration method to be described later.

The board information display area 23 is an area for displaying integrated board information in a display pattern selected with the display pattern selection buttons 22.

By way of the overall setting screen, the integration server 10 inputs a specification of a display pattern of integrated board information by an action on the display pattern selection buttons 22 (step S5) and determines a setting of the checkboxes in the base exchange selection area 21 for selecting a base exchange (step S6).

In accordance with the base exchange and the display pattern, the integration server 10 performs the integration process of integrating pieces of board information received from the plurality of cryptocurrency exchanges (step S7). The integration process will be described later in detail.

After creating integrated board information by executing the integration process, the integration server 10 displays the integrated board information in the board information display area 23 of the overall setting screen on the electronic device 14 (step S8).

When receiving a specification of a different base exchange or display pattern from an electronic device 14 via its overall setting screen (No in step S9, step S5, S6), the integration server 10 similarly creates integrated board information by the integration process (step S7) and causes the electronic device 14 to display the integrated board information (step S8).

When an end of displaying the integrated board information is commanded from an electronic device 14 (Yes in step S9), the integration server 10 ends provision of the integrated board information to the electronic devices 14.

Next, the integration process in the present embodiment will be described in detail.

The following description will be made about a case where a piece of board information A for the cryptocurrency (BTC) on the cryptocurrency exchange A of which a main currency is Japanese yen (JPY), a piece of board information B for the cryptocurrency (BTC) on the cryptocurrency exchange B of which a main currency is United States dollar (USD), and a piece of board information C for the cryptocurrency (BTC) on the cryptocurrency exchange C of which a main currency is Euro (EUR) are integrated. Note that the number of pieces of board information to be integrated is not limited to a specific number. In addition, the main currencies are not limited to Japanese yen (JPY), United States dollar (USD), and Euro (EUR) and can include other currencies. Moreover, it is possible not only to integrate pieces of board information from cryptocurrency exchanges that deal in different main currencies but also to integrate pieces of board information from a plurality of cryptocurrency exchanges that deal in the same main currency (e.g., Japanese yen (JPY)).

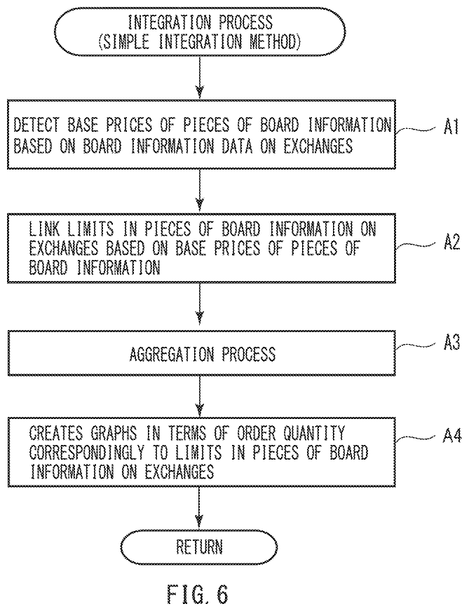

First, the integration process according to the simple integration method in a case where the display pattern 4 is specified with the display pattern button 22-4 in the overall setting screen will be described. FIG. 6 is a flowchart for explaining the integration process according to the simple integration method in the present embodiment.

In the integration process according to the simple integration method, the pieces of board information A, B, and C from a plurality of cryptocurrency exchanges A, B, and C are integrated by linking together base prices of the pieces of board information A, B, and C and arranging contents of the pieces of board information A, B, and C side by side.

The processor 10A detects base prices of the pieces of board information A, B, and C based on board information data from the plurality of cryptocurrency exchanges A, B, and C stored in the storage 10C (step A1).

The base prices are prices that indicate market prices at a time point between the cryptocurrency and the main currencies in the cryptocurrency exchanges and are prices each indicating, for example, any point between a lowest selling limit order and a highest buying limit order. Note that the prices each indicating any point are determined, for example, based on different criteria, such as a final market price, an average of a lowest selling limit and a highest buying limit, between cryptocurrency exchanges. The present embodiment will be described assuming that the base price is a price corresponding to any one of the kinds of information described above provided by the exchanges.

The processor 10A links together limits in the pieces of board information A, B, and C with respect to the base prices of the pieces of board information A, B, and C, so as to integrate the pieces of board information A, B, and C (step A2).

In addition, based on data in the pieces of board information integrated (including all data items in the pieces of board information A, B, and C), the processor 10A performs an aggregation process of aggregating data items that are to be displayed as integrated board information (step A3). In the aggregation process, out of data items in the pieces of board information integrated, data items to be displayed as integrated board information are aggregated so that a situation of transactions in the plurality of cryptocurrency exchanges can be checked easily. Examples of the aggregation of the data items include totalizing order quantities, changing limit sections, removing unnecessary data, and the like.

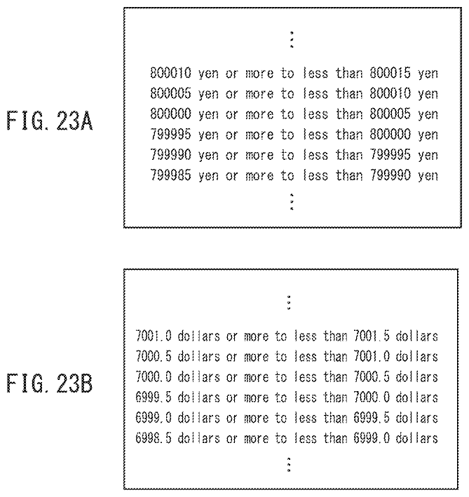

The aggregation process is not necessarily executed. Here, it is assumed in the description that the aggregation process is not executed, and all of the data items in the pieces of board information A, B, and C are to be displayed as integrated board information. The aggregation process will be described later in detail (FIG. 23 to FIG. 26).

The processor 10A creates graphs in terms of order quantity correspondingly to limits in the pieces of board information A, B, and C that are linked together with respect to the base prices (step A4). Here, bars corresponding to limits in the pieces of board information A, B, and C are plotted side by side.

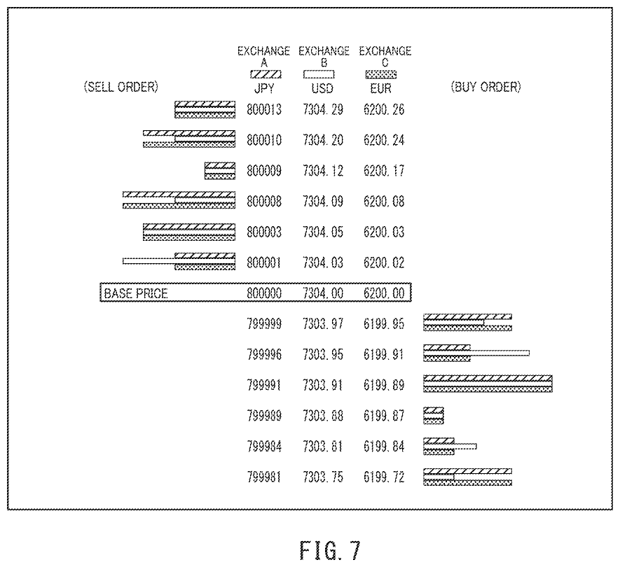

FIG. 7 is a diagram illustrating an example of integrated board information integrated into by the simple integration method in the present embodiment.

In the example illustrated in FIG. 7, a base price of the piece of board information A “80000 (JPY)”, a base price of the piece of board information B “7304.00 (USD)”, and a base price of the piece of board information C “6200.00 (EUR)” are arranged horizontally, and limits in the pieces of board information A, B, and C are linked together and arranged vertically from a base position. Here, bars corresponding to limits in the pieces of board information A, B, and C are disposed being plotted side by side.

With the integrated board information integrated into by the simple integration method in this manner, the pieces of board information on the plurality of cryptocurrency exchanges A, B, and C can be checked at the same time. Therefore, in a case where, for example, a limit order with a large quantity is placed in another cryptocurrency exchange different from a usual cryptocurrency exchange, this limit order can be recognized immediately. In addition, since limits are arranged being linked together with respect to the base prices of the pieces of board information A, B, and C, order quantities of selling limit orders and buying limit orders for each limit can be grasped easily. Therefore, whether there is any limit order with a large quantity at some limit can be grasped easily.

Note that since the integration method according to the simple integration process links together the base prices of the pieces of board information A, B, and C on the cryptocurrency exchanges, the linkage may not be made at the same price. That is, the base prices are not necessarily equal because the cryptocurrency exchanges A, B, and C trade cryptocurrencies independently of one another. For that reason, even when the base prices are converted based on exchange rates between the main currencies of the cryptocurrency exchanges, the base prices of the pieces of board information A, B, and C may not become the same price. For example, in the integrated board information illustrated in FIG. 7, the base prices of the pieces of board information A, B, and C are not necessarily “800000 (JPY)=7304.00 (USD)=6200.00 (EUR)”.

Furthermore, in buy-sell transactions of cryptocurrencies, tick sizes, each being a step size of a price in trading, may differ from one another between a plurality of cryptocurrency exchanges. For example, between different main currencies, correspondences between their price intervals equivalent to tick sizes change as an exchange rate therebetween fluctuates. In addition, even in a case of pieces of board information from cryptocurrency exchanges that deal in the same main currency, tick sizes may differ between the cryptocurrency exchanges.

For that reason, even when the base prices of and the limits in a plurality of pieces of board information A, B, and C are linked together by the integration method according to the simple integration method, there is a possibility that the linkage is not made at the same price.

By an integration process according to each of the first to third integration methods described below, linkage of base prices of and limits in a plurality of pieces of board information A, B, and C can be performed more appropriately than the linkage according to the simple integration method.

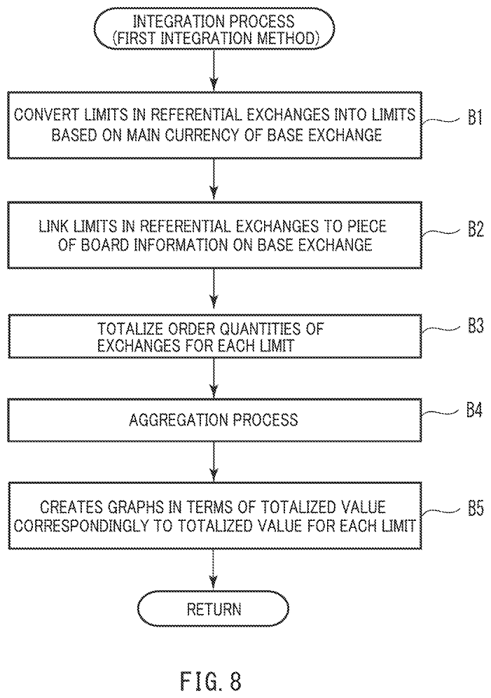

Next, an integration process according to the first integration method in a case where the display pattern 1 is specified with the display pattern button 22-1 in the overall setting screen will be described. FIG. 8 is a flowchart for explaining the integration process according to the first integration method in the present embodiment.

In the integration process according to the first integration method, the integration is performed with conversion using exchange rates with respect to absolute prices (limits). That is, in the integration process according to the first integration method, pieces of board information A, B, and C from a plurality of cryptocurrency exchanges A, B, and C are linked together to be integrated after limits in referential exchanges are converted in terms of a main currency of a base exchange based on exchange rates. The first integration method is a useful integration method in a case where the entire market including the plurality of cryptocurrency exchanges is efficient enough.

For example, in a situation where an exchange rate is 1 (USD)=100 (JPY), the market efficient enough is such that, while 1 BTC=1,000,000 yen in the cryptocurrency exchange A of which the main currency is Japanese yen, 1 BTC˜10,000 dollars in the cryptocurrency exchange B of which the main currency is United States dollar. That is, the market efficiently enough is a market where prices of a cryptocurrency are substantially equal to one another among cryptocurrency exchanges of which main currencies are different from one another.

The processor 10A converts limits in pieces of board information on referential exchanges into limits in terms of a main currency of a base exchange based on board information data from the plurality of cryptocurrency exchanges A, B, and C stored in the storage 10C (step B1). For example, in a case where the cryptocurrency exchange A is designated as the base exchange, the cryptocurrency exchanges B and C are the referential exchanges.

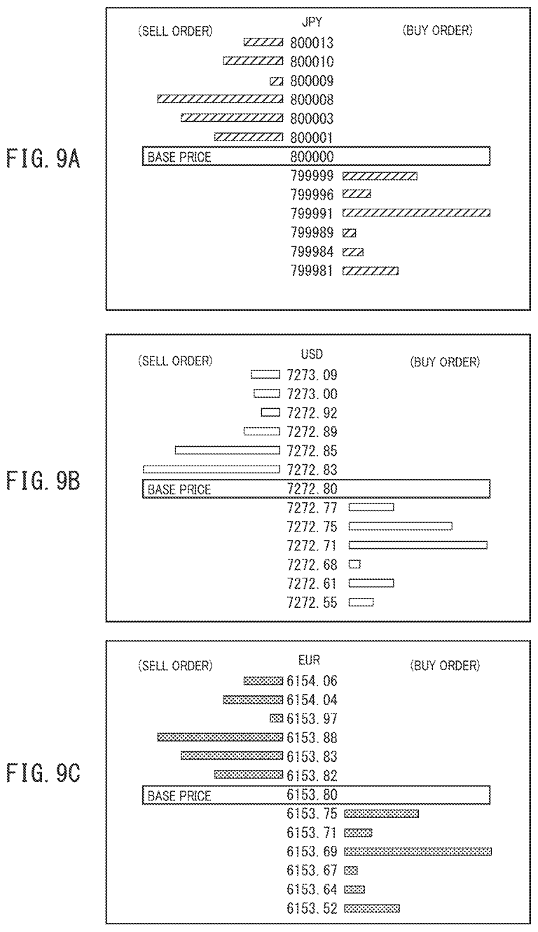

FIGS. 9A, 9B, and 9C illustrate an example of the pieces of board information A, B, and C received from the cryptocurrency exchanges A, B, and C, respectively. Based on an exchange rate between Japanese yen (JPY), which is the main currency of the cryptocurrency exchange A, and United States dollar (USD), which is the main currency of the cryptocurrency exchange B, the processor 10A converts limits in the piece of board information B into limits in Japanese yen (JPY). Similarly, based on an exchange rate between Japanese yen (JPY) and Euro (EUR), which is the main currency of the cryptocurrency exchange C, the processor 10A converts limits (including a base price) in the piece of board information C into limits in Japanese yen (JPY).

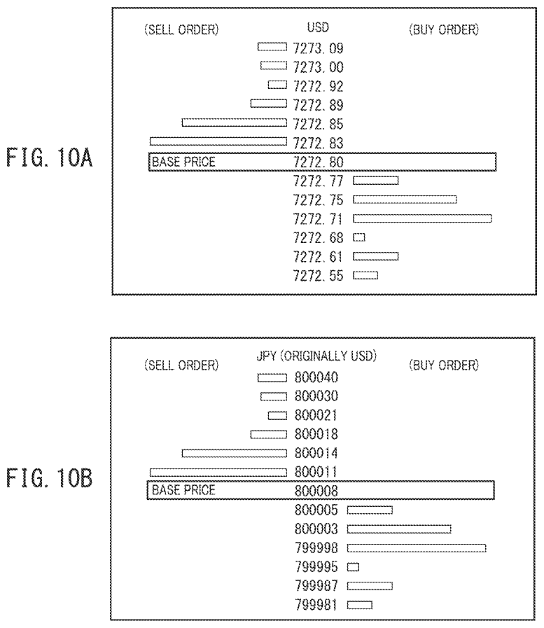

FIGS. 10A and 10B illustrate an example in which limits in the piece of board information B, of which the main currency is United States dollar (USD), are converted into limits in Japanese yen (JPY). For example, in a case where the exchange rate is 1 (USD)=110 (JPY), a limit in the piece of board information B, “7272.00 (USD)” (equivalent to the base price), is converted into “799920 (JPY)”. The processor 10A converts limits in the piece of board information B in United States dollar (USD) illustrated in FIG. 10A into limits in Japanese yen (JPY) based on the exchange rate, as illustrated in FIG. 10B.

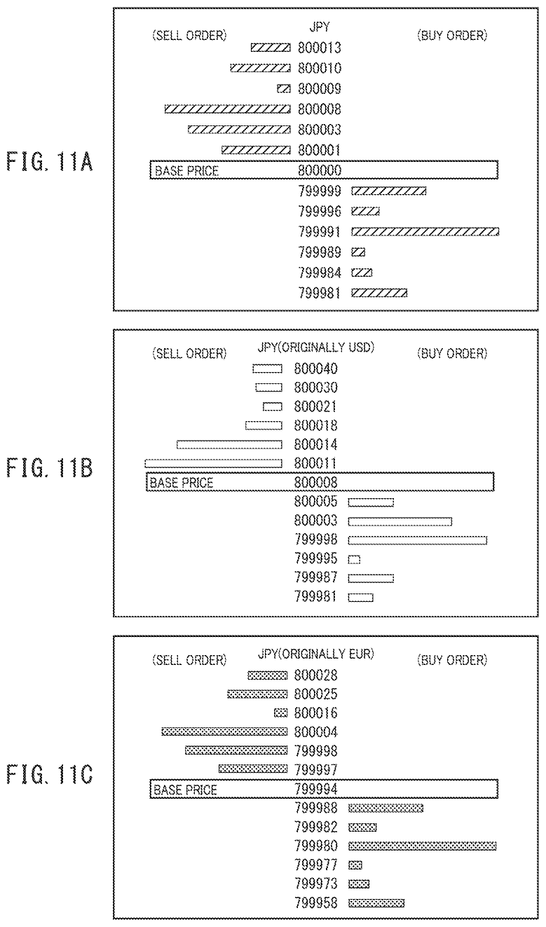

FIG. 11A illustrates the piece of board information A on the cryptocurrency exchange A being the base exchange, and FIGS. 11B and 11C illustrate, respectively, the pieces of board information B and C converted in terms of the main currency of the cryptocurrency exchange A (Japanese yen (JPY)). The processor 10A links the limits in the piece of board information A on the base exchange to the limits in the pieces of board information B and C converted in terms of the main currency (Japanese yen (JPY)) (step B2). That is, the processor 10A joins together the limits in the pieces of board information A, B, and C to generate limits in integrated board information.

The processor 10A calculates total order quantities obtained by totalizing order quantities of buy orders and sell orders in the pieces of board information A, B, and C, for each of the limits in the integrated board information into which the limits in the pieces of board information A, B, and C are integrated (step B3). For example, in a case where a limit in the piece of board information A and a limit in any of the pieces of board information B and C converted in terms of the main currency (Japanese yen (JPY)) have the same value, order quantities at the limit of the same value in the pieces of board information are totalized. For example, as illustrated in FIGS. 11A and 11B, there is a limit “799981 (JPY)” common to the pieces of board information A and B, and thus an order quantity at the limit “799981 (JPY)” in the piece of board information A and an order quantity at the limit “799981 (JPY)” in the piece of board information B are totalized to be an order quantity at the limit in the integrated board information. For limits that are not common to the plurality of pieces of board information, an order quantity at each of the limits in any one of the pieces of board information is set as an order quantity in the integrated board information. The integrated board information into which the pieces of board information A, B, and C are integrated is thereby generated.

In addition, based on data in the integrated pieces of board information, the processor 10A performs an aggregation process of aggregating data items that are to be displayed as integrated board information (step B4). As in the simple integration method, the aggregation process is not necessarily executed. The aggregation process will be described later in detail.

The processor 10A creates graphs in terms of order quantity correspondingly to limits in the integrated board information (limits made by joining together limits in the pieces of board information A, B, and C) (step B5).

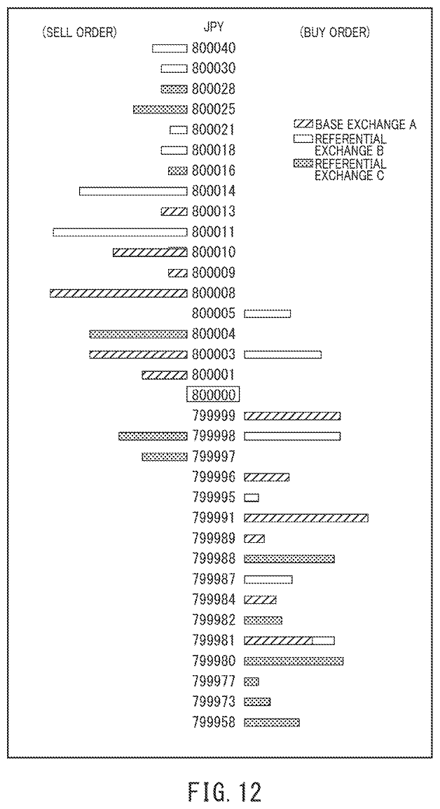

FIG. 12 is a diagram illustrating an example of integrated board information integrated into by the first integration method in the present embodiment. As illustrated in FIG. 12, the limits in the piece of board information A and the limits in the pieces of board information B and C converted into the limits in the main currency of the piece of board information A based on the exchange rates are joined together. In the example illustrated in FIG. 12, an order quantity at a limit “799981 (JPY)” shows that it is obtained by totalizing order quantities in the pieces of board information A and B. Order quantities at the other limits show that they are order quantities in the respective pieces of board information A, B, and C.

In the example illustrated in FIG. 12, a limit “800000” equivalent to the base price of the piece of board information A has no order quantity, but in a case where conversion of limits in the pieces of board information B and C based on the exchange rates results in a presence of the limit “800000”, order quantities at the limit “800000” in the pieces of board information B and C are expressed.

As above, with the integrated board information integrated into by the first integration method, in addition to the effects of the simple integration method, the integrated board information can be displayed in terms of the main currency of the cryptocurrency exchange designated as the base exchange. Therefore, order quantities at a limit in a main currency used for trading cryptocurrency in cryptocurrency exchanges dealing in other main currencies can be grasped easily. In addition, in the integration process according to the first integration method, in a case where the base prices at the cryptocurrency exchanges A, B, and C are different from one another, a range of selling limits with sell orders and a range of buying limits with buy orders overlap with each other as illustrated in the integrated board information in FIG. 12. Therefore, by referring to the integrated board information, differences (sizes of deviations) between the base prices at the cryptocurrency exchanges A, B, and C and sell/buy limit ranges with respect to the cryptocurrency at the plurality of cryptocurrency exchanges as a whole can be grasped easily.

Note that the integration process according the first integration method, which performs exchange conversion, inevitably involves a situation where deviation of absolute prices occurs due to exchange conversion, and thus comparison of actual trading between exchanges cannot be performed intuitively. In addition, although the integration process according to the first integration method is considered to be useful in a case where a market is efficient enough, in a situation where a market is not efficient enough, integrated board information in which pieces of board information on a plurality of cryptocurrency exchanges are joined together appropriately may not be obtained.

For example, in a situation where an exchange rate is 1 (USD)=100 (JPY), the market not efficient enough is such that, while 1 BTC=1,000,000 yen in the cryptocurrency exchange A of which the main currency is Japanese yen, 1 BTC˜10,000 dollars is not necessarily established in the cryptocurrency exchange B of which the main currency is United States dollar, and there can be a situation where, for example, 1 BTC=9,000 dollars. This can occur in a case where some factor (laws and regulations in countries, etc.) prohibits an operation “buy BTC using dollars in the United States, sell the BTC in Japan to obtain yen, and then convert the yen into dollars to make a profit (arbitrage)”. In a case where situations of restrictions imposed on cryptocurrencies differ between counties (cryptocurrency exchanges), in a country that imposes a strict restriction on the cryptocurrencies, a domestic price of BTC may significantly deviate from a price of BTC in the entire market including the other countries. In such a case, integrated board information as intended cannot be obtained by the exchange rate conversion with respect to an absolute price.

The second integration method or the third integration method to be described next is a useful integration method even in a case where a market is not efficient enough.

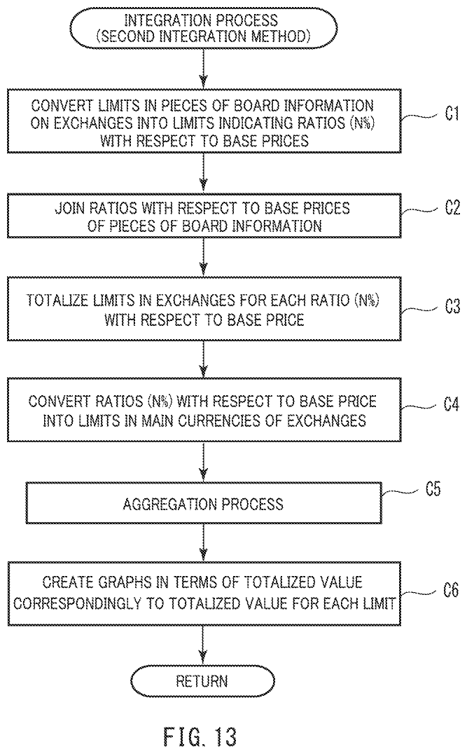

Next, an integration process according to the second integration method in a case where the display pattern 2 is specified with the display pattern button 22-2 in the overall setting screen will be described. FIG. 13 is a flowchart for explaining the integration process according to the second integration method in the present embodiment.

In the integration process according to the second integration method, limits in pieces of board information on a plurality of cryptocurrency exchanges are converted into ratios (proportions) with respect to their base prices, and the ratios corresponding to the limits in the pieces of board information are linked together to be integrated.

The processor 10A converts limits of pieces of board information A, B, and C on a plurality of cryptocurrency exchanges A, B, and C into limits indicating ratios (N%) with respect to their base prices based on board information data from the plurality of cryptocurrency exchanges A, B, and C stored in the storage 10C (step C1).

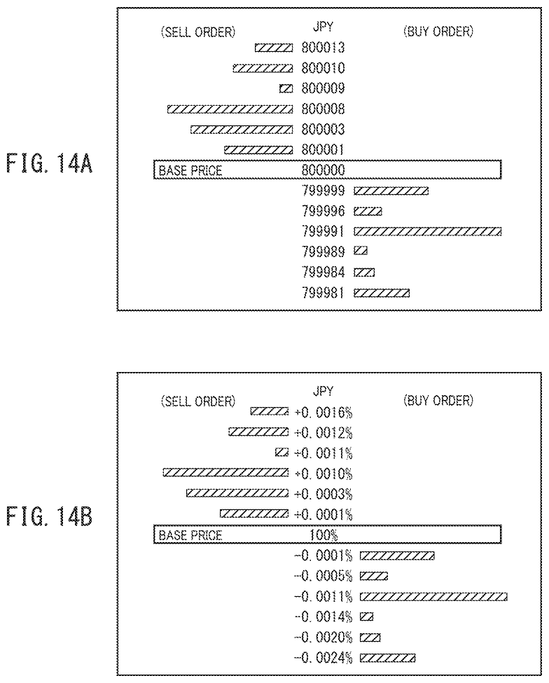

FIGS. 14A and 14B illustrate an example of converting limits in the piece of board information A on the cryptocurrency exchange A. FIG. 14A illustrates the piece of board information A before the conversion, and FIG. 14B illustrates an example of converting the limits in the piece of board information A into ratios with respect to its base price. As illustrated in FIG. 14A, assume that the base price of the piece of board information A is “800000 yen”. At this time, for example, a ratio of a limit “800800 yen” with respect to the base price (100%) is 100.1%. That is, a selling limit order for a price “800800 yen” is converted into “a selling limit order for a price of 100.1% with respect to the base price”.

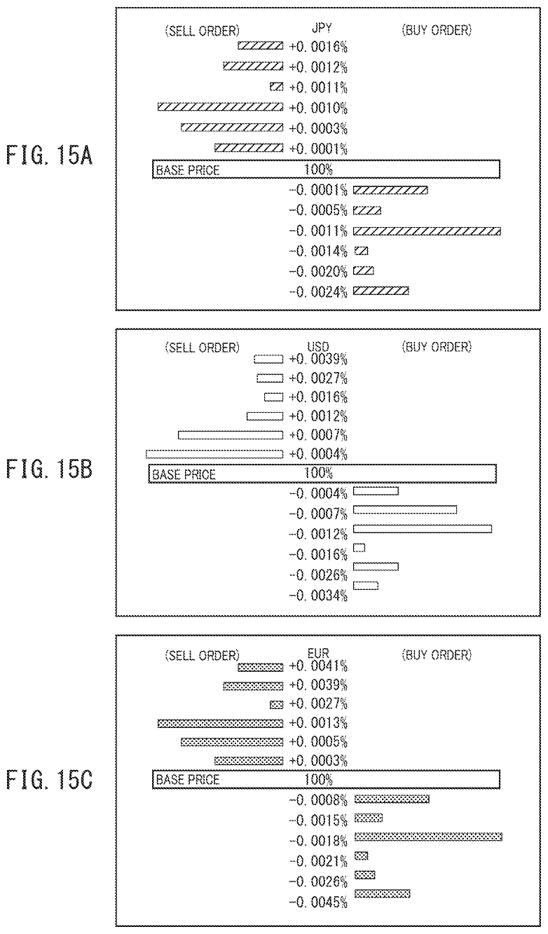

FIGS. 15A, 15B, and 15C illustrate pieces of board information into which limits in the pieces of board information A, B, and C are converted into limits indicating ratios (N%) with respect to their base prices, respectively.

The processor 10A joins together the ratios of the limits with respect to the base prices of the pieces of board information A, B, and C (step C2). That is, the processor 10A arranges the ratios corresponding to the limits in the pieces of board information A, B, and C to generate ratios corresponding to limits in integrated board information (integrated ratios).

The processor 10A calculates total order quantities obtained by totalizing order quantities of buy orders and sell orders in the pieces of board information A, B, and C, for each of the integrated ratios in the integrated board information into which the ratios of the limits in the pieces of board information A, B, and C are integrated (step C3). For example, in a case where a ratio corresponding to a limit in the piece of board information A and a ratio corresponding to a limit in the piece of board information B have the same value, order quantities at the ratio of the same value in the pieces of board information are totalized. For example, as illustrated in FIGS. 15A and 15C, there is a ratio with respect to a limit “+0.0003%” common to the pieces of board information A and C, and thus an order quantity at the ratio of the limit “+0.0003%” in the piece of board information A and an order quantity at the ratio of the limit “+0.0003%” in the piece of board information C are totalized to be an order quantity at the limit corresponding to the integrated ratio in the integrated board information. For ratios corresponding to limits that are not common to the plurality of pieces of board information, an order quantity at each of the limits in any one of the pieces of board information is set as an order quantity in the integrated board information. The pieces of board information A, B, and C are thereby integrated in accordance with the ratios corresponding to the limits.

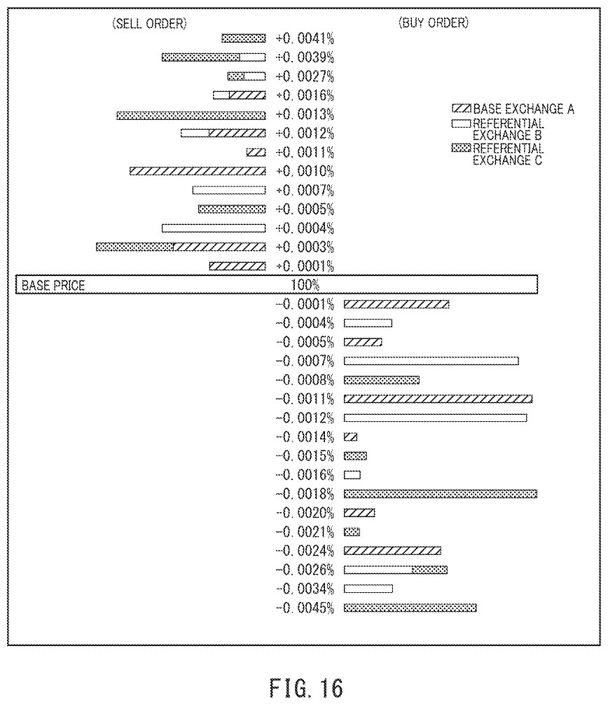

FIG. 16 illustrates an example of the integrated board information into which the pieces of board information A, B, and C are integrated in accordance with the ratios corresponding to the limits in the pieces of board information A, B, and C. The integrated board information illustrated in FIG. 16 shows order quantities of numerical values indicating ratios with respect to a base price (integrated ratios) rather than limits in a main currency. The processor 10A converts the numerical values indicating the ratios with respect to the base price illustrated in FIG. 16 into limits in main currencies of the cryptocurrency exchanges to generate integrated board information including the limits in the main currencies (step C4).

In addition, based on data in the integrated pieces of board information, the processor 10A performs an aggregation process of aggregating data items that are to be displayed as integrated board information (step C5). As in the simple integration method, the aggregation process is not necessarily executed. The aggregation process will be described later in detail.

The processor 10A creates graphs in terms of order quantity correspondingly to limits in the integrated board information (limits in the joined pieces of board information A, B, and C) (step C6).

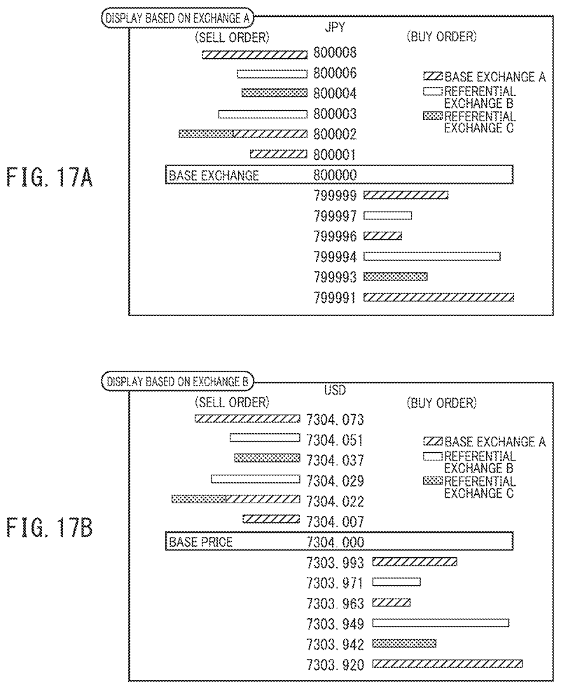

FIGS. 17A and 17B are diagrams illustrating an example of integrated board information integrated into by the second integration method in the present embodiment. A piece of the integrated board information illustrated in FIG. 17A is an example in which the limits are expressed in terms of Japanese yen, which is the main currency of the cryptocurrency exchange A, and a piece of the integrated board information illustrated in FIG. 17B is an example in which the limits are expressed in terms of United States dollar, which is the main currency of the cryptocurrency exchange B.

As above, in the integrated board information integrated into by the second integration method, in addition to the effects of the simple integration method, limits in pieces of board information on a plurality of cryptocurrency exchanges are converted into ratios (proportions) with respect to their base prices, and the ratios corresponding to the limits in the pieces of board information are linked together to be integrated. Even when the base prices of cryptocurrencies in the cryptocurrency exchanges A, B, and C are different from one another, order quantities at relatively the same values with respect to the base prices can be thereby presented in an integrated manner. In addition, the situation in which the deviation of absolute prices by the exchange conversion makes it difficult to grasp comparison of actual trading between exchanges intuitively can be mitigated.

Note that, in a case where the second integration method is used, the integrated board information expressed with the ratios with respect to the base price (integrated ratios) illustrated in FIG. 16 or the integrated board information expressed with the limits in the main currencies illustrated in FIGS. 17A and 17B may be used.

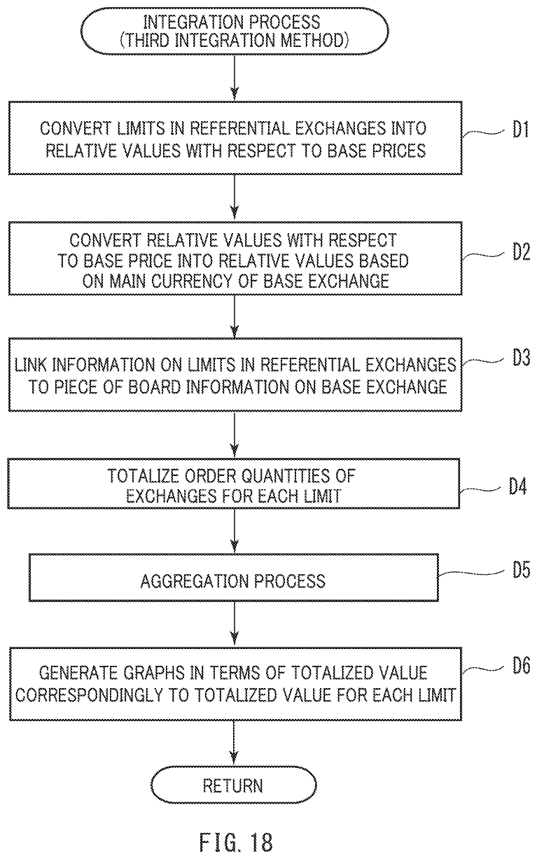

Next, an integration process according to the third integration method in a case where the display pattern 3 is specified with the display pattern button 22-3 in the overall setting screen will be described. FIG. 18 is a flowchart for explaining the integration process according to the third integration method in the present embodiment.

In the integration process according to the third integration method, limits in pieces of board information on a plurality of cryptocurrency exchanges are converted into relative values with respect to their base prices, and the relative values corresponding to the limits in the pieces of board information are converted into relative values with respect to a base price in a main currency of a base exchange based on exchange rates and integrated.

The processor 10A converts limits in pieces of board information on referential exchanges into relative values with respect to the base price based on board information data from the plurality of cryptocurrency exchanges A, B, and C stored in the storage 10C (step D1). For example, in a case where the cryptocurrency exchange A is designated as the base exchange, the cryptocurrency exchanges B and C are the referential exchanges.

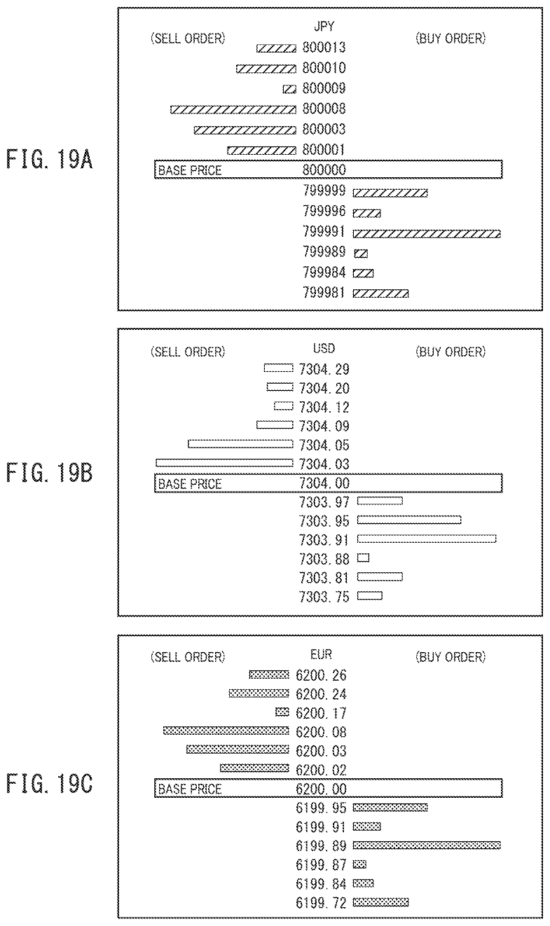

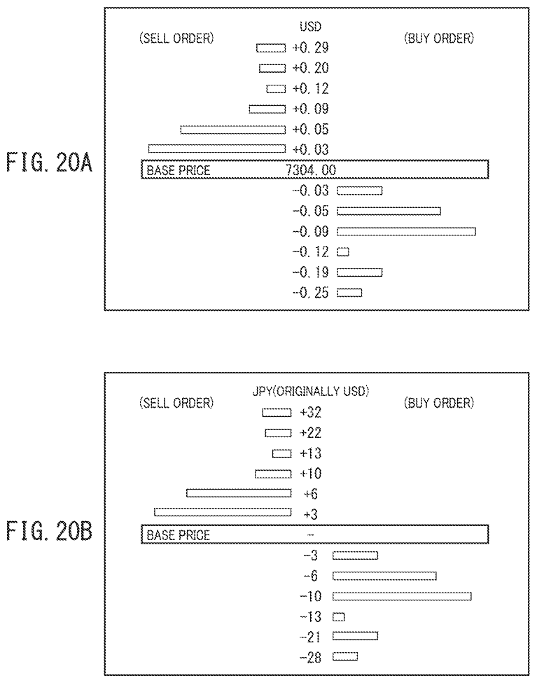

FIGS. 19A, 19B, and 19C illustrate an example of the pieces of board information A, B, and C received from the cryptocurrency exchanges A, B, and C, respectively. FIG. 20A illustrates an example in which limits in the piece of board information B on a referential exchange are converted into relative values with respect to its base price. The base price of the piece of board information B illustrated in FIG. 19B is “7304.00 (USD)”, and thus a limit “7304.03 (USD)” is converted into a relative value “+0.03” with respect to the base price as illustrated in FIG. 20A. That is, a selling limit order for a price “7304.00(USD)” is converted into “a selling limit order for a price being +0.03 with respect to the base price”. The processor 10A converts limits in the piece of board information B into relative values with respect to its base price. Similarly, for the piece of board information C illustrated in FIG. 19C, the processor 10A converts limits in the piece of board information C into relative values with respect to its base price “6200.00(EUR)”.

Next, based on an exchange rate between Japanese yen (JPY), which is the main currency of the cryptocurrency exchange A, and United States dollar (USD), which is the main currency of the cryptocurrency exchange B, the processor 10A converts the relative values with respect to the base price of the piece of board information B into relative values in Japanese yen (JPY) (step D2). Similarly, based on an exchange rate between Japanese yen (JPY) and Euro (EUR), which is the main currency of the cryptocurrency exchange C, the processor 10A converts relative values with respect to the base price of the piece of board information C into relative values in Japanese yen (JPY).

FIG. 20B illustrates an example in which the relative values with respect to the base price of the piece of board information B are converted into the relative values in Japanese yen (JPY). For example, in a case where the exchange rate is 1 (USD)=110 (JPY), a relative value “+0.03” with respect to the base price of the piece of board information B is converted into a relative value “+3” in Japanese yen. That is, a selling limit order for a relative value “+0.03” with respect to the base price of the piece of board information B is converted into a selling limit order for a price being “+3” with respect to the base price of the piece of board information A.

The processor 10A converts the relative values with respect to the base price of the piece of board information B illustrated in FIG. 20A into relative values in Japanese yen (JPY) based on the exchange rate, as illustrated in FIG. 20B.

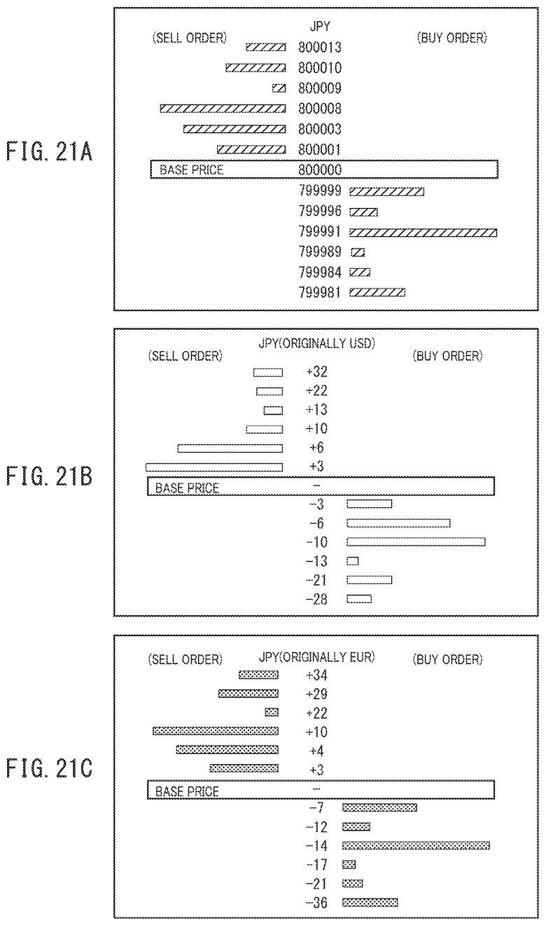

FIG. 21A illustrates the piece of board information A on the cryptocurrency exchange A being the base exchange, and FIGS. 21B and 21C illustrate, respectively, the pieces of board information B and C converted into relative values in the main currency of the cryptocurrency exchange A (Japanese yen (JPY)). The piece of board information C illustrated in FIG. 21C is an example in which the exchange rate is 1 (EUR)=130 (JPY). The processor 10A links the limits in a piece of board information A on the base exchange to pieces of information on the limits in the pieces of board information B and C on the referential exchanges that are converted in terms of the main currency of the piece of board information A (Japanese yen (JPY)) (step D3). That is, the limits in the piece of board information A and values obtained by adding relative values in the pieces of board information B and C converted in terms of the main currency (Japanese yen (JPY)) to the base price of the piece of board information A are linked and joined together, so as to generate limits in the integrated board information. For example, a relative value “+6” in the piece of board information B illustrated FIG. 21B is added to the base price “800000” of the piece of board information A to be calculated into a value “800006” and is joined to the limits in the piece of board information A. A relative value “−7” in the piece of board information C illustrated in FIG. 21C is added to the base price “800000” of the piece of board information A to be calculated into a value “799993” and is joined to the limits in the piece of board information A.

The processor 10A calculates total order quantities obtained by totalizing order quantities of buy orders and sell orders in the pieces of board information A, B, and C, for each of the limits in the integrated board information into which the limits in the pieces of board information A, B, and C are integrated (step D4). For example, in a case where a limit in the piece of board information A and a value obtained by converting a relative value in any of the pieces of board information B and C into the main currency have the same value, order quantities at the limit of the same value in the pieces of board information are totalized. For example, as illustrated in FIGS. 21B and 21C, since there is a relative value “+3” common to the pieces of board information B and C, an order quantity at a limit “800003 (JPY)” in the piece of board information A, an order quantity at a limit “7304.03 (USD)” in the piece of board information B corresponding to the relative value “+3”, and an order quantity at a limit “6200.02 (EUR)” in the piece of board information C corresponding to the relative value “+3” are totalized to be an order quantity at the limit in the integrated board information. For limits that are not common to the plurality of pieces of board information, an order quantity at each of the limits in any one of the pieces of board information is set as an order quantity in the integrated board information. The pieces of board information A, B, and C are thereby integrated.

In addition, based on data in the integrated pieces of board information, the processor 10A performs an aggregation process of aggregating data items that are to be displayed as integrated board information (step D5). As in the simple integration method, the aggregation process is not necessarily executed. The aggregation process will be described later in detail.

The processor 10A creates graphs in terms of order quantity correspondingly to limits in the integrated board information (limits in the joined pieces of board information A, B, and C) (step D6).

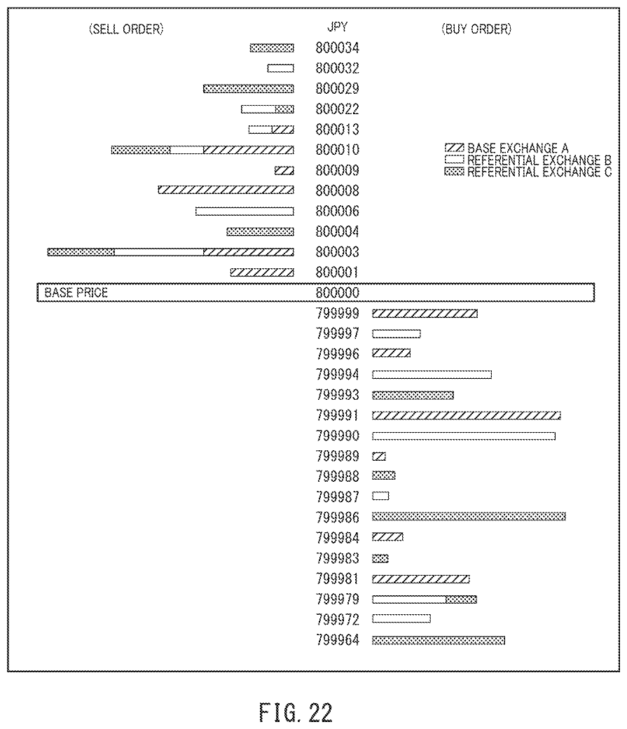

FIG. 22 illustrates an example of the integrated board information into which the piece of board information A is integrated based on relative values of the limits with respect to the base prices of the pieces of board information B and C. In the integrated board information illustrated in FIG. 22, relative values of the limits with respect to the base prices of the pieces of board information B and C are converted into limits in the main currency of the piece of board information A to be joined with the limits in the piece of board information A.

As above, in the integrated board information integrated into by the third integration method, as with the second integration method, even when the base prices of cryptocurrencies in the cryptocurrency exchanges A, B, and C are different from one another, order quantities at relatively the same values with respect to the base prices can be presented in an integrated manner.

Next, the aggregation process in the present embodiment will be described.

In the simple integration method and the first to third integration methods stated above, integrated board information including all of the limits in the plurality of pieces of board information A, B, and C to be integrated is generated. Additionally, by executing the aggregation process, board information data is aggregated for ease of checking a situation of trading the cryptocurrency in the plurality of cryptocurrency exchanges.

The integration server 10 in the present embodiment is capable of executing any one of a first aggregation process, a second aggregation process, and a third aggregation process described below. The first to third aggregation processes will be each described below.

In the first aggregation process, a method that divides limits in board information into constant price ranges, summarizes order quantities for each price range, and displays summarized order quantities is adopted.

FIGS. 23A and 23B illustrate an example of dividing limits in board information by the first aggregation process in the present embodiment. FIG. 23A illustrates an example of dividing limits in integrated board information of which a main currency is Japanese yen. In the example illustrated in FIG. 23A, the limits are divided by a predetermined value (5 yen). FIG. 23B illustrates an example of dividing limits in integrated board information of which a main currency is United States dollar. In the example illustrated in FIG. 23B, the limits are divided by a predetermined value (0.5 dollars).

On the board information into which the plurality of pieces of board information A, B, and C are integrated, the processor 10A aggregates a sectional order quantity, which is obtained by totalizing order quantities corresponding to limits included in a price range divided into, for each section. In addition, the processor 10A links any one of the limits included in each section to a sectional order quantity corresponding to the section to generate integrated board information after the aggregation process.

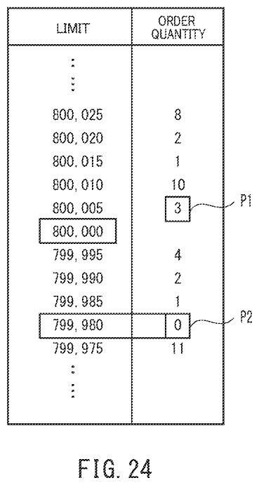

FIG. 24 is a diagram illustrating an example of data included in integrated board information after the first aggregation process in the present embodiment. FIG. 24 illustrates limits that correspond to the sections illustrated in FIG. 23A and are shown in the integrated board information and sectional order quantities that correspond to the limits (sections).

For example, for a section being a price range of limits “800000 yen” or more to less than “800005 yen” in the integrated board information, a limit “800005 yen”, which is the largest value of the section, is used as a limit of the section. Note that another limit such as a median value and the smallest value of the section, may be used as a limit corresponding to the section. In the example illustrated in FIG. 24, it is indicated that a sum P1 of order quantities corresponding to limits included in the price range of limits “800000 yen” or more to less than “800005 yen” is “5”. In the first aggregation process, order quantities being “0”, such as a sum P2 corresponding to a limit “799980 yen”, are also included in the integrated board information.

Note that a width (price range) used for the division may be a preset fixed value or may be a parameter for controlling the aggregation process specified by a user via the overall setting screen.

The first integration method and the third integration method divide limits in board information, whereas the second integration method divides integrated ratios, which are obtained by joining ratios corresponding to limits in pieces of board information to be integrated with respect to their base prices, by a constant width. The processor 10A calculates a sectional order quantity, which is obtained by totalizing order quantities corresponding to ratios included in a section, and links one of the ratios included in the section to a sectional order quantity corresponding to the section to generate the integrated board information.

As above, in the first aggregation process, limits are divided using the constant price range, and order quantities corresponding to limits included in a section are totalized; thus, the number of limits to be shown in the integrated board information can be reduced. Therefore, in a case where a total number of limits becomes large by joining limits in a plurality of pieces of board information A, B, and C, the number of limits in the integrated board information can be reduced to the number that makes it easy to check the integrated board information.

Next, the second aggregation process will be described. In the second aggregation process, a method that performs division using price ranges that become narrower as being closer to a base price of board information, summarizes order quantities for each price range, and displays summarized order quantities is adopted.

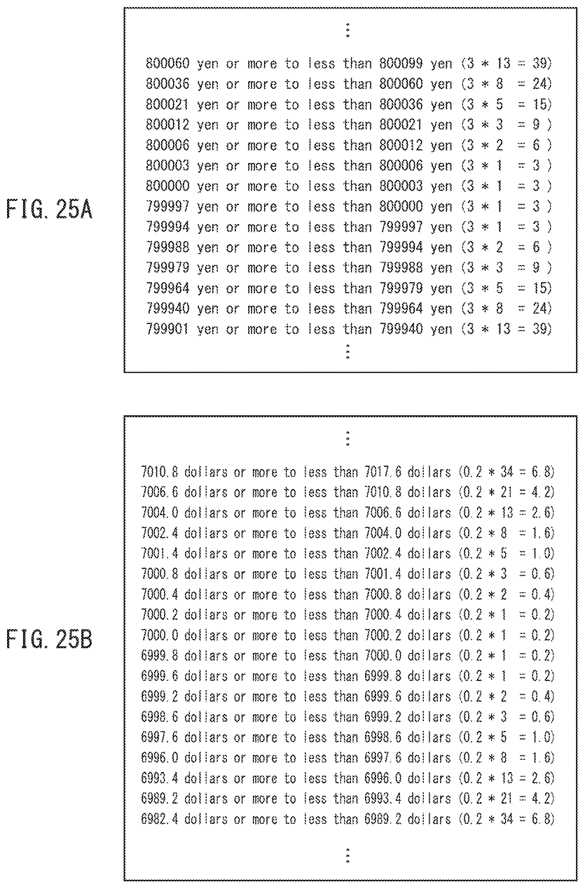

FIGS. 25A and 25B illustrate an example of dividing limits in board information by the second aggregation process in the present embodiment. FIG. 25A illustrates an example of dividing limits in integrated board information of which a main currency is Japanese yen.

In the second aggregation process in the present embodiment, the division is performed using price ranges that become narrower as being closer to a base price of board information; for example, the division is performed using price ranges based on the Fibonacci sequence. For example, when a first price range closest to the base price is set to 1 (N=1), the division is performed using price ranges 1, 1, 2, 3, 5, 8, . . . from the base price. Alternatively, when the first price range is set to 5 (N=5), the division is performed using price ranges 5, 5, 10, 15, 25, 40, . . . from the base price.

In the example illustrated in FIG. 25A, a first price range closest to a predetermined base price is set to “3 yen”, price ranges adjacent to the base price “800000 yen” are set to “799997 yen” or more to less than “800005 yen” and “800000 yen” or more to less than “800003 yen”, and a price interval of a section is widened as being farther from the base price.

FIG. 25B illustrates an example of dividing limits in integrated board information of which a main currency is United States dollar. In the example illustrated in FIG. 25B, a first price range closest to a predetermined base price is set to “0.2 dollars”, price ranges adjacent to the base price “7000.0 dollars” are set to “6999.8 dollars” or more to less than “7000.0 dollars” and “7000.0 dollars” or more to less than “7000.2 dollars”, and a price interval of a section is widened as being farther from the base price.

As with the first aggregation process, the processor 10A aggregates a sectional order quantity, which is obtained by totalizing order quantities corresponding to limits included in a price range divided into, for each section, and links one of the limits included in the section to a sectional order quantity corresponding to the section to generate the integrated board information after the aggregation process.

Note that the first price range closest to the base price may be a preset fixed value or may be a parameter for controlling the aggregation process specified by a user via the overall setting screen.

The first integration method and the third integration method divide limits in board information, whereas the second integration method divides integrated ratios, which are obtained by joining ratios corresponding to limits in pieces of board information to be integrated with respect to their base prices, by a constant width. The processor 10A calculates a sectional order quantity, which is obtained by totalizing order quantities corresponding to ratios included in a section, and links one of the ratios included in the section to a sectional order quantity corresponding to the section to generate the integrated board information.

As above, in the second aggregation process, the division is performed using the price ranges that become narrower as being closer to the base price of the board information, and the integrated board information in which order quantities are summarized for each section can be generated. Therefore, at price ranges close to the base price, which are important to determine the trading of cryptocurrency, detailed buy-and-sell order quantities can be checked for each of narrow price ranges, and a situation of an overall buy-and-sell order quantity including price ranges away from the base price (the balance between selling limits and buying limits) can be easily checked.

Next, the third aggregation process will be described. In the third aggregation process, a method that extracts and shows only limits at which order quantities are not less than a certain value (base value) is adopted.

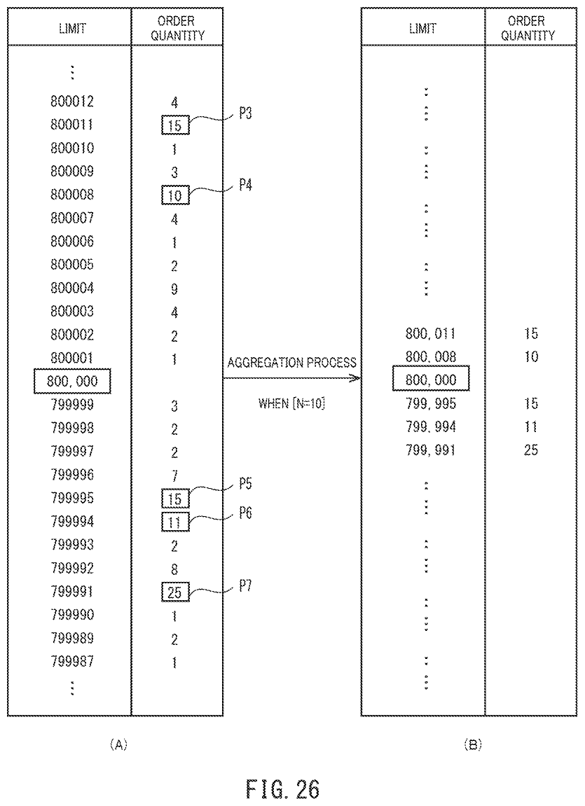

(A) and (B) of FIG. 26 illustrate an example of generating integrated board information by the third aggregation process in the present embodiment. (A) of FIG. 26 illustrates limits and order quantities in the integrated board information in which main currencies are integrated into Japanese yen. Here, in a case where a base value N as a condition for extracting limits is “10”, the processor 10A detects order quantities not less than “10” out of order quantities corresponding to the limits illustrated in (A) of FIG. 26. In (A) of FIG. 26, order quantities P3 to P7 apply to the condition.

As illustrated in (B) of FIG. 26, the processor 10A extracts only limits corresponding to the order quantities P3 to P7 as limits in the integrated board information and generates the integrated board information including the order quantities corresponding to the limits.

As above, in the third aggregation process, the integrated board information including only limits at which order quantities are not less than the certain value (base value) is generated, and thus orders to buy or sell with large order quantities can be easily grasped. Here, since limits at which order quantities are not less than the certain value are extracted from the integrated board information into which the plurality of cryptocurrency exchanges A, B, and C are integrated; therefore, even an order in each of the cryptocurrency exchanges A, B, and C has an order quantity being less than the certain value can be grasped in the entire market as a limit at which an order quantity is not less than the certain value.

Note that the certain value (base value) used for the division may be a preset fixed value or may be a parameter for controlling the aggregation process specified by a user via the overall setting screen.

Note that, in the above description, buy and sell order quantities at limits are shown as graphs when board information is displayed, but the order quantities may be simply shown as numerical values. Furthermore, although the graphs used to display the board information described above are bar charts, but other kinds of graphs can be used.

In addition, in the above description, the integration server 10 is configured to provide the integrated board information integrated into by any integration method selected from the simple integration method and the first to third integration methods, but the integration server 10 may be configured to provide the integrated board information integrated into by any one of the integration methods. In addition, the integration server 10 may be configured to provide the integrated board information integrated into by any combination selected from combinations of the simple integration method and the first to third integration methods.

While certain embodiments of the present invention have been described, these embodiments have been presented by way of example only and are not intended to limit the scope of the invention. These embodiments can be embodied in a variety of other forms; furthermore, various omissions, substitutions, and changes can be made without departing from the gist of the present invention. These embodiments and their modifications are included in the scope and the gist of the invention and included in the inventions described in claims and equivalents of the inventions.

In addition, methods of the processes described in the embodiments can be stored in a recording medium such as a magnetic disk, an optical disk, and a semiconductor memory or can be transferred to be distributed over a communication medium, in a form of a program capable of causing a computer to execute the processes. A computer that implements an image processing apparatus reads the program recorded in the recording medium, and the processes described above are executed by the program controlling operation. Note that the recording medium is not limited to a recording medium for distribution; the recording medium includes a recording medium such as a magnetic disk and a semiconductor memory that is provided inside a computer or in equipment connected over a network.

(Supplement)

A server that is connected to an electronic device and systems of a plurality of cryptocurrency exchanges over a network includes: an information reception unit configured to receive, from a system of a first cryptocurrency exchange that conducts buy-sell transactions of a cryptocurrency in a first main currency, first board information that includes a buy-sell order quantity for each of a plurality of first limits in the first main currency with respect to the cryptocurrency and receive, from a system of a second cryptocurrency exchange that conducts buy-sell transactions of the cryptocurrency in a second main currency, second board information that includes a buy-sell order quantity for each of a plurality of second limits in the second main currency with respect to the cryptocurrency; a determination unit configured to determine a second base price corresponding to a first base price based on an exchange rate between the first main currency and the second main currency, the first base price indicating a market price of the cryptocurrency in the first board information, the second base price indicating a market price of the cryptocurrency in the second board information; and a display unit configured to link the first limits to the second limits in accordance with a correspondence between the first base price and the second base price, link buy-sell order quantities at the first limits to buy-sell order quantities at the second limits, and display the first limits, the second limits, the buy-sell order quantities at the first limits, and the buy-sell order quantities at the second limits on the electronic device.

A computer readable storage medium records a program for causing a computer to implement: means for receiving, from a system of a first cryptocurrency exchange that conducts buy-sell transactions of a cryptocurrency in a first main currency, first board information that includes a buy-sell order quantity for each of a plurality of first limits in the first main currency with respect to the cryptocurrency and receiving, from a system of a second cryptocurrency exchange that conducts buy-sell transactions of the cryptocurrency in a second main currency, second board information that includes a buy-sell order quantity for each of a plurality of second limits in the second main currency with respect to the cryptocurrency; means for converting the second limits into third limits in the first main currency based on the exchange rate between the first main currency and the second main currency; means for calculating a total order quantity obtained by totalizing buy-sell order quantities in the first board information and the second board information, for each of fourth limits into which the first limits and the third limits are joined; and means for displaying third board information that includes the total order quantities corresponding to the fourth limits in the first board information and the second board information, on an external electronic device.

A computer readable storage medium records a program for causing a computer to implement: means for receiving, from a system of a first cryptocurrency exchange that conducts buy-sell transactions of a cryptocurrency in a first main currency, first board information that includes a buy-sell order quantity for each of a plurality of limits in the first main currency with respect to the cryptocurrency and receiving, from a system of a second cryptocurrency exchange that conducts buy-sell transactions of the cryptocurrency in a second main currency, second board information that includes a buy-sell order quantity for each of a plurality of limits in the second main currency with respect to the cryptocurrency; means for converting, based on a first base price indicating a market price of the cryptocurrency in the first board information, limits in the first board information into ratios with respect to the first base price and converting, based on a second base price indicating a market price of the cryptocurrency in the second board information, limits in the second board information into ratios with respect to the second base price; means for calculating a total order quantity obtained by totalizing buy-sell order quantities in the first board information and the second board information, for each of integrated ratios into which ratios corresponding to the limits in the first board information and ratios corresponding to the limits in the second board information are joined; and means for displaying third board information that includes the total order quantities corresponding to the integrated ratios in the first board information and the second board information, on an external electronic device.

A computer readable storage medium records a program for causing a computer to implement: means for receiving, from a system of a first cryptocurrency exchange that conducts buy-sell transactions of a cryptocurrency in a first main currency, first board information that includes a buy-sell order quantity for each of a plurality of first limits in the first main currency with respect to the cryptocurrency and receiving, from a system of a second cryptocurrency exchange that conducts buy-sell transactions of the cryptocurrency in a second main currency, second board information that includes a buy-sell order quantity for each of a plurality of second limits in the second main currency with respect to the cryptocurrency; means for converting the first limits into first relative values with respect to a base price that indicates a market price of the cryptocurrency in the second board information; means for converting the first relative values into second relative values in the first main currency based on the exchange rate between the first main currency and the second main currency; means for calculating a total order quantity obtained by totalizing buy-sell order quantities corresponding to the second relative values in the first board information and the second board information, for each of fourth limits into which the first limits and third limits are joined, the third limits being obtained by adding the second relative values to the first limits; and means for displaying third board information that includes the total order quantities corresponding to the fourth limits in the first board information and the second board information, on an external electronic device.

A computer readable storage medium records a program for causing a computer to implement: means for receiving, from a system of a first cryptocurrency exchange that conducts buy-sell transactions of a cryptocurrency in a first main currency, first board information that includes a buy-sell order quantity for each of a plurality of first limits in the first main currency with respect to the cryptocurrency and receiving, from a system of a second cryptocurrency exchange that conducts buy-sell transactions of the cryptocurrency in a second main currency, second board information that includes a buy-sell order quantity for each of a plurality of second limits in the second main currency with respect to the cryptocurrency; means for determining a second base price corresponding to a first base price based on an exchange rate between the first main currency and the second main currency, the first base price indicating a market price of the cryptocurrency in the first board information, the second base price indicating a market price of the cryptocurrency in the second board information; and means for linking the first limits to the second limits in accordance with a correspondence between the first base price and the second base price, linking buy-sell order quantities at the first limits to buy-sell order quantities at the second limits, and displaying the first limits, the second limits, the buy-sell order quantities at the first limits, and the buy-sell order quantities at the second limits on an external electronic device.

### REFERENCE SIGNS LIST

10 . . . integration server, 10A . . . processor, 10B . . . memory, 10C . . . storage, 10D . . . input device, 10E . . . output device, 10F . . . communication device, 12 (12-1, 12-2, . . ., 12-n) . . . exchange server, 14 (14-1, . . ., 14-k) . . . electronic device, 16 . . . exchange rate provision server, 18 . . . network, 21 . . . base exchange selection area, 22 (22-1, 22-2, 22-3, 22-4) . . . display pattern selection button, 23 . . . board information display area

1. A server that is connected to an electronic device and systems of a plurality of cryptocurrency exchanges over a network, the server comprising:
an information reception unit configured to receive, from a system of a first cryptocurrency exchange that conducts buy-sell transactions of a cryptocurrency in a first main currency, first board information that includes a buy-sell order quantity for each of a plurality of first limits in the first main currency with respect to the cryptocurrency and receive, from a system of a second cryptocurrency exchange that conducts buy-sell transactions of the cryptocurrency in a second main currency, second board information that includes a buy-sell order quantity for each of a plurality of second limits in the second main currency with respect to the cryptocurrency;
a conversion unit configured to convert the second limits into third limits in the first main currency based on an exchange rate between the first main currency and the second main currency;
a totalization unit configured to calculate a total order quantity obtained by totalizing buy-sell order quantities in the first board information and the second board information, for each of fourth limits into which the first limits and the third limits are joined; and
a display unit configured to display third board information that includes the total order quantities corresponding to the fourth limits in the first board information and the second board information, on the electronic device.

2. The server according to claim 1, further comprising
an aggregation unit configured to divide the fourth limits into sections being predetermined constant price ranges and aggregate total order quantities at the fourth limits included in each of the sections, to totalize the total order quantities into a sectional order quantity for each section, wherein
the display unit displays the third board information in which a limit included in the section is linked to the sectional order quantity corresponding to the section, on the electronic device.

3. The server according to claim 1, further comprising
an aggregation unit configured to divide the fourth limits into sections being price ranges that become narrower as being closer to a base price indicating a market price of the cryptocurrency in the first board information and aggregate total order quantities at the fourth limits included in each of the sections, to totalize the total order quantities into a sectional order quantity, wherein
the display unit displays the third board information in which a limit included in the section is linked to the sectional order quantity corresponding to the section, on the electronic device.

4. The server according to claim 1, further comprising
an aggregation unit configured to aggregate only the fourth limits of which the total order quantities are not less than a preset base value, wherein
the display unit displays the fourth limits of which the total order quantities are not less than the base value and the third board information that includes only the total order quantities corresponding to the fourth limits, on the electronic device.

5. A server that is connected to an electronic device and systems of a plurality of cryptocurrency exchanges over a network, the server comprising:
an information reception unit configured to receive, from a system of a first cryptocurrency exchange that conducts buy-sell transactions of a cryptocurrency in a first main currency, first board information that includes a buy-sell order quantity for each of a plurality of limits in the first main currency with respect to the cryptocurrency and receive, from a system of a second cryptocurrency exchange that conducts buy-sell transactions of the cryptocurrency in a second main currency, second board information that includes a buy-sell order quantity for each of a plurality of limits in the second main currency with respect to the cryptocurrency;
a conversion unit configured to convert, based on a first base price indicating a market price of the cryptocurrency in the first board information, limits in the first board information into ratios with respect to the first base price and convert, based on a second base price indicating a market price of the cryptocurrency in the second board information, limits in the second board information into ratios with respect to the second base price;
a totalization unit configured to calculate a total order quantity obtained by totalizing buy-sell order quantities in the first board information and the second board information, for each of integrated ratios into which ratios corresponding to the limits in the first board information and ratios corresponding to the limits in the second board information are joined; and
a display unit configured to display third board information that includes the total order quantities corresponding to the integrated ratios in the first board information and the second board information, on the electronic device.

6. The server according to claim 5, further comprising
an aggregation unit configured to divide the integrated ratios into sections being a predetermined constant width and aggregate total order quantities at ratios included in each of the sections, to totalize the total order quantities into a sectional order quantity for each section, wherein
the display unit displays the third board information in which a ratio included in the section is linked to the sectional order quantity corresponding to the section, on the electronic device.

7. The server according to claim 5, further comprising
an aggregation unit configured to divide the integrated ratios into sections being widths that become narrower as being closer to a base price indicating a market price of the cryptocurrency in the first board information and aggregate total order quantities at the ratios included in each of the sections, to totalize the total order quantities into a sectional order quantity for each section, wherein
the display unit displays the third board information in which a ratio included in the section is linked to the sectional order quantity corresponding to the section, on the electronic device.

8. The server according to claim 5, further comprising
an aggregation unit configured to extract ratios corresponding to limits on the first board information of which the total order quantities are not less than a preset base value, wherein
the display unit displays the ratios corresponding to limits on the first board information of which the total order quantities are not less than the base value and the third board information that includes only the total order quantities corresponding to the ratios, on the electronic device.

9. A server that is connected to an electronic device and systems of a plurality of cryptocurrency exchanges over a network, the server comprising:
an information reception unit configured to receive, from a system of a first cryptocurrency exchange that conducts buy-sell transactions of a cryptocurrency in a first main currency, first board information that includes a buy-sell order quantity for each of a plurality of first limits in the first main currency with respect to the cryptocurrency and receive, from a system of a second cryptocurrency exchange that conducts buy-sell transactions of the cryptocurrency in a second main currency, second board information that includes a buy-sell order quantity for each of a plurality of second limits in the second main currency with respect to the cryptocurrency;
a first conversion unit configured to convert the first limits into first relative values with respect to a base price that indicates a market price of the cryptocurrency in the second board information;
a second conversion unit configured to convert the first relative values into second relative values in the first main currency based on an exchange rate between the first main currency and the second main currency;
a totalization unit configured to calculate a total order quantity obtained by totalizing buy-sell order quantities corresponding to the second relative values in the first board information and the second board information, for each of fourth limits into which the first limits and third limits are joined, the third limits being obtained by adding the second relative values to a base price of the first limits; and
a display unit configured to display third board information that includes the total order quantities corresponding to the fourth limits in the first board information and the second board information, on the electronic device.

10. The server according to claim 9, further comprising
an aggregation unit configured to divide the fourth limits into sections being predetermined constant price ranges and aggregate total order quantities at the fourth limits included in each of the sections, to totalize the total order quantities into a sectional order quantity for each section, wherein
the display unit displays the third board information in which a limit included in the section is linked to the sectional order quantity corresponding to the section, on the electronic device.

11. The server according to claim 9, further comprising
an aggregation unit configured to divide the fourth limits into sections being price ranges that become narrower as being closer to a base price indicating a market price of the cryptocurrency in the first board information and aggregate total order quantities at the fourth limits included in each of the sections, to totalize the total order quantities into a sectional order quantity, wherein
the display unit displays the third board information in which a limit included in the section is linked to the sectional order quantity corresponding to the section, on the electronic device.

12. The server according to claim 9, further comprising
an aggregation unit configured to aggregate only the fourth limits of which the total order quantities are not less than a preset base value, wherein
the display unit displays the fourth limits of which the total order quantities are not less than the base value and the third board information that includes only the total order quantities corresponding to the fourth limits, on the electronic device.
